(19) United States
(12) Patent Application Publication
(10) Pub. No.: US 2019/0092154 A1
(43) Pub. Date: Mar. 28, 2019

(54) HAIL STONE DEFLECTING MOTOR VEHICLE COVER AND METHOD

(71) Applicant: Edward G. Gorlo, WHEATRIDGE, CO (US)

(72) Inventor: Edward G. Gorlo, WHEATRIDGE, CO (US)

(21) Appl. No.: 16/139,003

(22) Filed: Sep. 22, 2018

Related U.S. Application Data
(60) Provisional application No. 62/562,394, filed on Sep. 23, 2017.

(51) Int. Cl. B60J 11/04

(52) U.S. Cl. CPC B60J 11/04

(57) ABSTRACT

A high impact hail deflecting cover for a motor vehicle is provided. The cover has a plurality of semi-rigid corrugated plastic sheets. The sheets are connected in a foldable matrix configuration. The matrix is adapted to fold for storage and unfold to conform to an exterior surface shape of a motor vehicle.

### CROSS REFERENCE TO RELATED APPLICATIONS

This application claims the benefit of U.S. Provisional Application Ser. No. 62/562,394, filed 23 Sep. 2017.

### STATEMENT OF FEDERALLY SPONSORED RESEARCH

None.

### BACKGROUND OF THE INVENTION

### 1. Field of the Invention

The present invention relates to motor vehicle covers. In particular, it relates to an improved high impact hail deflecting motor vehicle cover.

### 2. Description of the Related Art

Motor vehicle covers are well known. Such covers are generally made using sections of laminated fabric material which is sewn from a vehicle specific pattern. The laminated construction is generally configured to protect the motor vehicle from various environmental elements, such as ultra-violet light, rain, and/or dirt.

Thunderstorms are high risks weather events well known for inflicting considerable damage to motor vehicles. The level of damage varies considerable depending upon the nature of the storm, the storm may arise with little warning, and may release hailstones ranging from pea to baseball sized. This obviously has potential to wreak considerable damage to windows and external body panels of motor vehicles. In the prior art, certain motor vehicle deployable covers are known and are disclosed as being capable of absorbing a hail impact.

One such cover is disclosed in U.S. Pat. Pub. Ser. No. US2014/0015274 to Banda. Banda teaches a rapidly installable barrier for protecting the upwardly facing horizontal surfaces of a motor vehicle from falling hail. The barrier is a cover sheet which covers upwardly exposed surfaces of the motor vehicle and an absorbent panel capable of resisting impact of hail. The absorbent panel is an array of parallel cushion panels having a folding joint disposed between each two adjacent cushion panels. The cushion panels may be enclosed within a sleeve which protects them from liquid and solid contaminants, and preferably, ultraviolet rays. The sleeve may be one common sleeve, or plural sleeves each enclosing one or more cushion panels. The barrier may include magnets enclosed within the sleeve or sleeves for adhering to steel vehicle bodies, and straps bearing connectors for engaging axle components of the motor vehicle.

While the foregoing impact absorbing barrier offers some utility, in protecting a motor vehicle from a light hail event, what is needed is an improved a rapidly deployable motor vehicle cover which is capable of deflecting, rather than absorbing, a large sized hail stone in a high impact storm event. The present invention satisfies these needs.

### BRIEF SUMMARY OF THE INVENTION

It is therefore an object of the present invention to provide an improved a rapidly deployable foldable motor vehicle cover which is capable of deflecting large sized hail stone in a high impact storm event.

To overcome the problems of the prior art and in accordance with the purpose of the invention, as embodied and broadly described herein, briefly a high impact hail deflecting cover for a motor vehicle is provided. The cover has a plurality of semi-rigid corrugated plastic sheets. The sheets are connected in a foldable matrix configuration with a laminate, crease or fold. The matrix is adapted to fold for ease in storage and to unfold so as to conform to an exterior surface shape of a motor vehicle to be protected.

Additional advantages of the present invention will be set forth in part in the description that follows and in part will be obvious from that description or can be learned from practice of the invention. The advantages of the invention can be realized and obtained by the articles of apparel particularly pointed out in the appended claims.

### BRIEF DESCRIPTION OF THE SEVERAL VIEWS OF THE DRAWINGS

The accompanying drawings, which are incorporated in and which constitute a part of the specification illustrate at least one embodiment of the invention and, together with the description, explain the principles of the invention.

FIG. 1 is a prospective view of a motor vehicle covered with the present invention after unfolding.

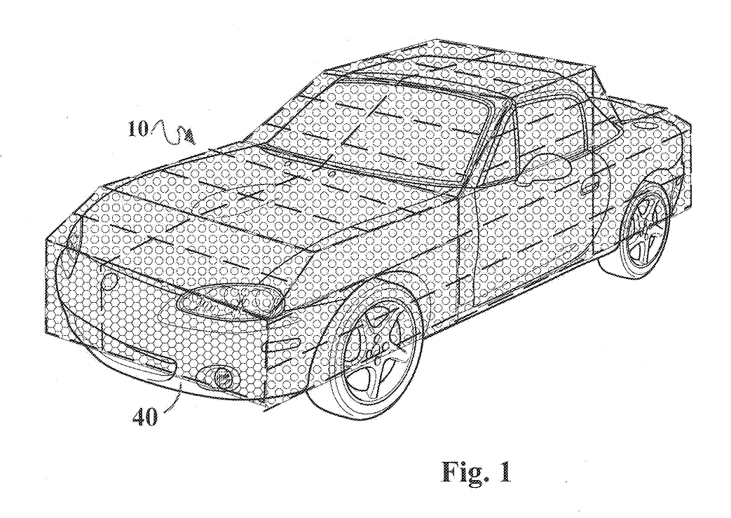

FIG. 2 is a cross-section of at least one of the presently preferred embodiment of the present invention.

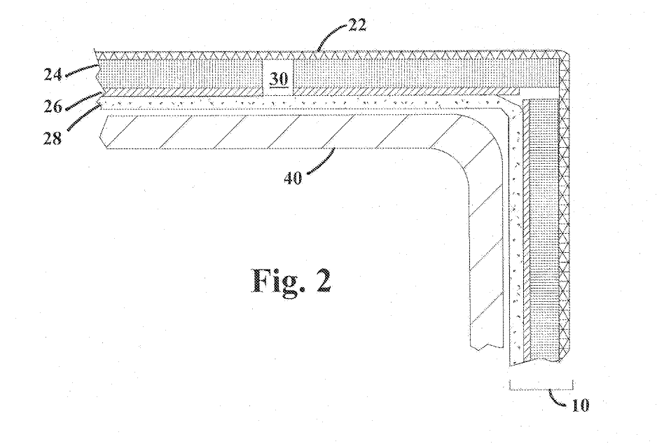

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

Referring now to drawing figures, the present invention provides a foldable high impact hail deflecting motor vehicle 40 cover 10. The cover 10 is foldable for ease in storage, and expansion as a matrix adapted to protect the vehicle 40 to be covered. The sheets 24 are a corrugated plastic sheet which is manufactured as being foldable in a roll, or as a panel of a larger sheet. The use of a corrugated plastic sheet substrate, for purposes of the present invention, is an important functional element because the inner vertical, or angular rib portions of the sheets are the members which deflect the high impact kinetic energy of a sever hail storm event. In this manner, the use of the corrugated panel, as opposed to the prior art materials, actually deflect the hail stones as opposed to absorbing the impact, as with the prior art covers described above.

The means for folding is either one of a score, crease, fluted or fabric lamination. The sheets 24 are desirably secured to the vehicle 40 using, any method which is well known, such as a hook and loop fabric, attachable/removable wall hang hooks for cords, elastic cords, eyelets or clamps or the like. Cords may be of a high tensile strength steel located to in any one of the score, crease, or flute so as to traverse a horizontal section of the motor vehicle to be protected, and having enlarged ends adapted to be secured in either one of a door or window when closed. In this manner, the cords secure the cover to the horizontal section of the motor vehicle to be protected against theft.

Where larger corrugated plastic sheets 24 are desirable, depending upon the intended use, the means for folding is with a fabric laminated over a void 30 between the sheets 24. The sheets 24, whether provided in a roll or larger sheet configuration, are desirably in a thickness range of between 2-16 mm.

The corrugated plastic sheets are desirable laminated on either the inner surface or outer surface depending upon the intended use. The fabric laminate, 22, 26, may be of a adhesively attached fabric or a brushed fabric. Where provided in a rolled configuration, a fluted inside laminate or outside laminate may be provided. The fabric lamination is desirable a brushed inner 26 and/or outer 22 microfiber or polyester laminate. In a presently preferred embodiment, the inner laminate 26 is desirably a microfiber laminated rolls or sheets offered by Coroplast™. The microfiber is desirable as an inner laminate because of its abrasion protection.

Another such preferred brushed laminate, for use with the present invention, is a microfilament laminated polypropylene also offered as a Coroplast™ as laminated roll or large sheet. The microfilament fabric combines the presently preferred good textile and mechanical properties. Like microfiber, it is also soft and lightweight, but at the same time, it is very strong. Depending upon the intended use, the microfilaments make them desirable for use in lint-free and sensitive surface applications. The microfilament laminate(s) may, but need not, be cut, dyed, printed, and/or finished like other fabrics and depending upon intended use with logo indicia.

After unfolding, the sheets 24 are secured to the motor vehicle to be protected. As above, the sheet may be secured using any combination of hook and loop fabrics, eyelets, elastic cords, drop cloth attachable hook and loop assemblies, or secured using cables and locks of any type well which are well known in the art. However, in the presently preferred embodiment, one or more flexible magnet layers 28 are provided. The magnets 28 may, but need not, be configured as an adhered laminate layer , or embossed into any one of the inner 26 fabric laminate layers.

While the present invention has been described in connection with the embodiments as described and illustrated above, it will be appreciated and understood by one of ordinary skill in the art that many modifications may be made in the pattern and construction of the metallized film warm-up apparel, in accordance with the present invention, without departing from the true spirit and scope of the invention as described and broadly claimed herein.

I claim:

1. A high impact hail deflecting cover for a motor vehicle, comprising: a plurality of semi-rigid corrugated plastic sheets having a means for being connected in a foldable matrix configuration, said configuration being adapted to unfold to conform to an substantially exterior surface shape of a motor vehicle to be protected.

2. The impact deflecting cover according to claim 1, wherein the sheets are connected in a roll by a crease or flute.

3. The impact deflecting cover according to claim 1, wherein at least one of the sheets further includes an inner fabric laminate.

4. The impact deflecting cover according to claim 1, wherein at least one of the sheets further includes at least one inner magnetic surface.

5. The impact deflecting cover according to claim 1, wherein the crease or flute further includes at least one high tensile strength cord positioned to traverse a full section of at least one horizontal panel of the motor vehicle to be covered, said cord being to secure the cover to the vehicle.

6. The impact deflecting cover according to claim 3, wherein the inner laminate is a microfiber.

7. The impact deflecting cover according to claim 4, wherein said magnetic surface is an embossed magnetic sheet.

8. A method for protecting an exterior surface of a motor vehicle from an impact event, comprising the steps of:
(a) providing a plurality of semi-rigid corrugated plastic sheets having a means for being connected in a foldable matrix configuration, said configuration being adapted to unfold to conform to a substantially exterior surface shape of a motor vehicle to be protected.
(b) unfolding said matrix:
(c) covering said vehicle with said matrix; and
(d) securing said matrix to a portion of an exterior surface of said motor vehicle to be protected.

9. The method according to claim 8 further comprising the step of providing an inner fabric laminate to at least one of the sheets.

10. The method according to claim 8 further comprising the step of providing an inner magnet to at least one of said sheets and wherein the step of securing is using the magnet to adhere said sheet to an exterior of said vehicle to be protected.
